(19) United States
(12) Patent Application Publication
(10) Pub. No.: US 2019/0257935 A1
(43) Pub. Date: Aug. 22, 2019

(54) TIME DOMAIN REFLECTOMETRY INSTRUMENT WITH BOTTOM UP ALGORITHM

(71) Applicant: Magnetrol International, Incorporated, Aurora, IL (US)

(72) Inventor: Steven R. PAGE, Naperville, IL (US)

(73) Assignee: Magnetrol International, Incorporated, Aurora, IL (US)

(21) Appl. No.: 16/278,368

(22) Filed: Feb. 18, 2019

Related U.S. Application Data
(60) Provisional application No. 62/632,248, filed on Feb. 19, 2018.
(60) Provisional application No. 62/773,410, filed on Nov. 30, 2018.

(51) Int. Cl. G01S 13/10; G01S 7/40; G01F 23/284

(52) U.S. Cl. CPC G01S 13/106; G01F 23/284; G01S 7/4008

(57) ABSTRACT

A radar transmitter for emulsion measurement comprises a probe mountable to a bottom of a vessel and defining a transmission line extending upward into the vessel, in use, for sensing impedance. A pulse circuit is connected to the probe for periodically generating pulses on the transmission line and receiving a reflected signal from the transmission line, each reflected signal comprising a waveform of probe impedance over time. A controller is operatively connected to the pulse circuit and comprises a programmed processor and a memory. The memory stores trace data of a plurality of individual waveforms. The processor is programmed to profile a first section of the waveforms which does not change over time and a second section of the waveforms which changes over time, representing an emulsion moving in the vessel. The controller locates where the waveforms indicates motion to determine emulsion level.

### BACKGROUND OF THE INVENTION

### Field of the Invention

This invention relates to process control instruments, and more particularly, to use of a time domain reflectometry-based instrument for emulsion measurement using a bottom up algorithm.

### Background of the Invention

Process control systems require the accurate measurement of process variables. Typically, a primary element senses the value of a process variable and a transmitter develops an output having a value that varies as a function of the process variable. For example, a level transmitter includes a primary element for sensing level and a circuit for developing an electrical signal proportional to sensed level.

Knowledge of level in industrial process tanks or vessels has long been required for safe and cost-effective operation of plants. Many technologies exist for making level measurements. These include buoyancy, capacitance, ultrasonic and microwave radar, to name a few. Recent advances in micropower impulse radar (MIR), also known as ultra-wideband (UWB) radar, in conjunction with advances in equivalent time sampling (ETS), permit development of low power and lost cost time domain reflectometry (TDR) instruments.

In a TDR instrument, a very fast pulse with a rise time of 500 picoseconds, or less, is propagated down a probe that serves as a transmission line, in a vessel. The pulse is reflected by a discontinuity caused by a transition between two media. For level measurement, that transition is typically where the air and the material to be measured meet. These instruments are also known as guided wave radar (GWR) measurement instruments.

One type of probe used by GWR level instruments is the coaxial probe. The coaxial probe consists of an outer tube and an inner conductor. When a coaxial probe is immersed in the liquid to be measured, there is a section of constant impedance, generally air, above the liquid surface. An impedance discontinuity is created at the level surface due to the change in dielectric constant of the liquid versus air at this point. When the GWR signal encounters any impedance discontinuity in the transmission line, part of the signal is reflected back toward the source in accordance with theory based on Maxwell's laws. The GWR instrument measures the time of flight of the electrical signal to, and back from, this reflecting point, being the liquid surface, to find the liquid level.

Simple level measurement involves detecting the reflected signal from a single level surface, such as water or oil. A slightly more complex measurement is so-called “interface” measurement, in which a less dense medium such as oil floats on top of a heavier medium such as water.

Time Domain Reflectometry level instruments, like the one in U.S. Pat. No. 6,626,038, owned by the Applicant herein, transmit pulses from the top of a tank, down through air, toward the liquid stored in the tank. The pulses reflect off the liquid, and the instrument measures the time between the transmitted pulses and received reflections and converts that time into distance. Such an instrument can also detect the thickness of a layer of oil floating on top of water, because each interface, air-oil, and then oil-water, generates a reflection.

Instruments such as that disclosed in Applicant's U.S. Pat. No. 9,546,895 further analyze the reflected pulses, to give a profile of percent water in the fluid versus depth.

When these instruments attempt to measure a fluid which has significant water content, the reflected signals become smeared and greatly attenuated. This is due to water's well-known dielectric properties. The instrument in U.S. Pat. No. 9,546,895 uses a coating to mitigate water's negative effects. This technique offers the tradeoff between a thicker coating allowing deeper penetration into the water, but less sensitivity to the water.

These techniques have difficulty locating cloudy water near the bottom of a tank, which has only 20% oil, because the reflected signals are vanishingly small.

This application is directed to further improvements in level measurement.

### SUMMARY OF THE INVENTION

In accordance with the invention a time domain reflectometry-based instrument for emulsion measurement uses a bottom up algorithm.

In accordance with one aspect, a radar transmitter for emulsion measurement comprises a probe mountable to a bottom of a vessel and defining a transmission line extending upward into the vessel, in use, for sensing impedance. A pulse circuit is connected to the probe for periodically generating pulses on the transmission line and receiving a reflected signal from the transmission line, each reflected signal comprising a waveform of probe impedance over time. A controller is operatively connected to the pulse circuit and comprises a programmed processor and a memory. The memory stores trace data of a plurality of individual waveforms. The processor is programmed to profile a first section of the waveforms which does not change over time and a second section of the waveforms which changes over time, representing an emulsion moving in the vessel. The controller locates where the waveforms indicates motion to determine emulsion level.

It is a feature that the waveform comprises a time domain refiectometry signal.

It is another feature that the controller uses TDR inversion to transform the waveform into impedance relative to distance.

The controller may be programmed to use historical difference motion detection. The controller may compare a current waveform to a prior waveform a select time T prior to the current waveform.

The controller may be programmed to use modulated motion detection where there is relative movement between the emulsion and the probe. Modulated motion detection assembles all the waveform samples at time tSlice to create a waveform that has some amount of energy from the pumping period T, and detects a P(tSlice), the amount of fluid modulation Power at time t from the bottom of the probe for all time's out to the probe's farthest reach, and determines the first time P(tSlice) that crosses a threshold pTHRESH, and indicates that as the emulsion location.

The controller may be programmed to use linear motion detection. The linear motion detection creates an image of the moving edge from the plurality of individual waveforms and determines a slope of a line at the moving edge and an intersection point of the line along a time scale.

The controller may use random motion detection. The random motion detection creates a variance trace that is a point wise variance of all of the plurality of waveforms in a buffer and determines a reflection time there the variance trace crosses a select threshold.

Further features and advantages will be readily apparent from the drawings and the specification.

### BRIEF DESCRIPTION OF THE DRAWINGS

FIG. 1 is a sectional view of a process measurement instrument mounted at the bottom of a process vessel for measuring interface level;

FIG. 2 is a block diagram of a control circuit for the instrument of FIG. 1;

FIGS. 3A and 3B are curves of traces for a TDR waveform;

FIG. 4 is a waveform showing differences between the traces in FIG. 3A;

FIG. 5 illustrates an algorithm for modulated fluid motion detection;

FIGS. 6A-6G illustrate an algorithm for linear motion detection; and

FIG. 7 is a series of curves illustrating a TDR reflection moving around in time.

### DETAILED DESCRIPTION OF THE INVENTION

A radar transmitter for emulsion measurement comprises a probe defining a transmission line for sensing impedance. A pulse circuit is connected to the bottom of the probe for generating upward travelling pulses on the transmission line and receiving a reflected signal from the transmission line. The reflected signal comprises a waveform of probe impedance over time. A controller is operatively connected to the pulse circuit. The controller profiles a section of waveform which is un-changing, because the probe is submerged in a fluid with water on the bottom, and a part which changes over time, which is an emulsion moving due to settling or pumping. The controller locates where the waveform indicates motion, and reports that distance to a user.

This device is attempting to find the location of an Oil in Water emulsion floating upon cleaner water. The device may comprise a conventional time domain reflectometry measurement instrument as described in Applicant's U.S. Pat. No. 6,626,038, the specification of which is incorporated by reference herein. However, in the embodiment herein, the probe extends upwardly from the bottom of the vessel and the programming would implement a bottom up algorithm described herein.

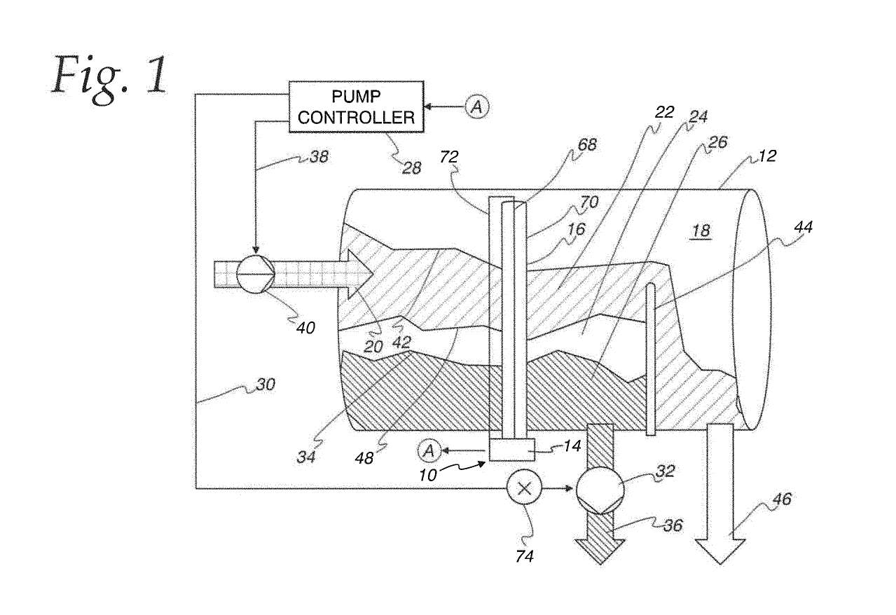

FIG. 1 illustrates a process instrument 10 mounted to a vessel 12. Particularly, the process instrument 10 is mounted to the bottom of the vessel 12. The process instrument 10 uses pulse radar in conjunction with equivalent time sampling (ETS) and ultra-wide band (UWB) transceivers for measuring level using time domain reflectometry (TDR). Particularly, the instrument 10 uses guided wave radar for sensing level. While the embodiment described herein relates to a guided wave radar level sensing apparatus, various aspects of the invention may be used with other types of process instruments for measuring various process parameters.

The process instrument 10 includes a controller 14 for connecting to a probe 16. The probe 16 is mounted in any known manner at the bottom of the vessel 12 with the probe 16 extending upwardly into the interior 18 of the vessel 12. The probe 16 comprises a high frequency transmission line which, when placed in a fluid, can be used to measure level of the fluid. Particularly, the probe 16 is controlled by the controller 14 for determining level in the vessel 12.

In a separation application illustrated in FIG. 1, water/oil flow enters the vessel 12 at an inlet 20, where gravity separates it into oil 22, emulsion 24 and water 26. A pump controller 28 uses a signal path 30 to set a pumping rate for a pump 32 so that the emulsion-bottom level 34 stays high enough to prevent emulsion 24 from entering water flow 36. The pump controller 28 uses a signal path 38 to set an inlet rate for an inlet pump 40 so that oil level 42 is above a weir 44 giving oil flow 46 out of the vessel 12. The pump controller 28 monitors emulsion top level 48 and halts the inlet pump 40 if emulsion 24 gets close to flowing over the weir 44. The separator's ultimate goal is to separate the incoming stream 20 into two separate streams 36 and 46, with nearly pure water and oil, respectively.

Applications purposely pump out water which settles to the bottom, so typically water is much less than half the total fluid column height. This means the cloudy emulsion is closer to the bottom than it is to the top. Also, a signal path on the probe 16 travelling from the bottom up to the emulsion is homogenous water, whereas the path travelling from the top down to the water travels through air, oil, and other unknown layers. For these reasons, this probe 16 is controlled to fire the pulses upwards, instead of the traditional downward firing.

The emulsion lowers fluid dielectric, which results in the TDR return signal or trace deviating upward from a pure water trace. The algorithm described here uses that deviation.

Guided wave radar combines TDR, ETS and low power circuitry. TDR uses pulses of electromagnetic (EM) energy to measure distanced or levels. When a pulse reaches a dielectric discontinuity then a part of the energy is reflected. The greater the dielectric difference, the greater the amplitude of the reflection. In the measurement instrument 10, the probe 16 comprises a wave guide with a characteristic impedance in air. When part of the probe 16 is immersed in a material other than air, there is lower impedance due to the increase in the dielectric. When the EM pulse is sent up the probe it meets the dielectric discontinuity and a reflection is generated.

ETS is used to measure the high speed, low power EM energy. The high speed EM energy (1000 foot/microsecond) is difficult to measure over short distances and at the resolution required in the process industry. ETS captures the EM signals in real time (nanoseconds) and reconstructs them in equivalent time (milliseconds), which is much easier to measure. ETS is accomplished by scanning the wave guide to collect thousands of samples. Approximately five scans are taken per second.

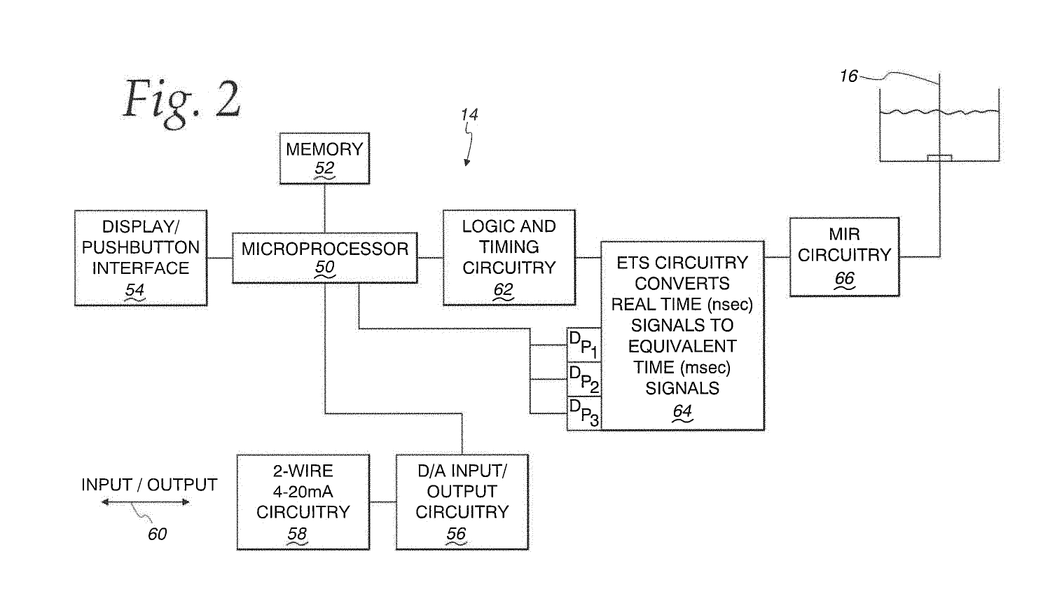

Referring to FIG. 2, the electronic circuitry of the controller 14 of FIG. 1 is illustrated in block diagram form. As will be apparent, the probe 16 could be used with other controller designs.

The controller 14 includes a microprocessor 50 connected to a suitable memory 52 (the combination forming a computer) and a display/push button interface 54. The display/push button interface 54 may be used for entering parameters with a keypad and displaying user information. The memory 52 comprises both non-volatile memory for storing programs for implementing the emulsion measurement described herein and calibration parameters, as well as volatile memories used during level measurement, as described below.

The microprocessor 50 is also connected to digital to analog (D/A) input/output circuitry 56 which is in turn connected to 2-wire 4-20 mA circuitry 58 for connecting to remote devices as represented by an input/output line 60. Particularly, the 2-wire circuitry 58 utilizes loop control and power circuitry which is well known and commonly used in process instrumentation. The power is provided on the line 60 from an external power supply. The circuitry 58 controls the current on the 2-wire line 60 which represents level or other characteristics measured by the probe 16. Moreover, the signal line 60 may include digital information using techniques well known in the industry.

The microprocessor 50 is also connected via logic and timing circuitry 62 to an ETS circuit 64. The logic and timing circuitry 62 converts signals to appropriate levels and coordinates timing of such signal levels. The ETS circuitry 64 is connected via MIR circuitry 66 to the probe 16. The ETS circuitry 64 and the MIR circuitry 66 are known and generally in accordance with the teachings of McEwen U.S. Pat. Nos. 5,345,471 and 5,609,059, the specifications of which are hereby incorporated by reference herein.

As will be apparent, other circuitry could be used to implement the bottom up algorithms described herein.

The general concept implemented by the ETS circuit 64 is known. The MIR circuitry 66 generates hundreds of thousands of very fast pulses of 500 picoseconds or less rise time every second. The timing between pulses is tightly controlled. The reflected pulses are sampled at controlled intervals. The samples build a time multiplied “picture” of the reflected pulses. Since these pulses travel on the probe 16 at the speed of light, this picture represents approximately ten nanoseconds in real time for a five-foot probe. The MIR circuitry 66 converts the time to about seventy-one milliseconds. As is apparent, the exact time would depend on various factors, such as, for example, probe length. The largest signals have an amplitude on the order of twenty millivolts before amplification to the desired amplitude by common audio amplifiers. For a low power device, a threshold scheme is employed to give interrupts to the microprocessor 50 for select signals, namely, fiducial, target, level, and end of probe, as described below. The microprocessor 50 converts these timed interrupts into distance. With the probe length entered through the display/push button interface 54, or some other interface, the microprocessor 50 can calculate the level by subtracting from the probe length the difference between the fiducial and level distances. Changes in measured location of the reference target can be used for velocity compensation, as necessary or desired.

As described above, the emulsion 24 shown in FIG. 1 is present between the oil 22 and water 26 and comprises an oil/water mixture. This emulsion can produce an undesirable effect on TDR traces received from the probe 16 during the measurement cycles.

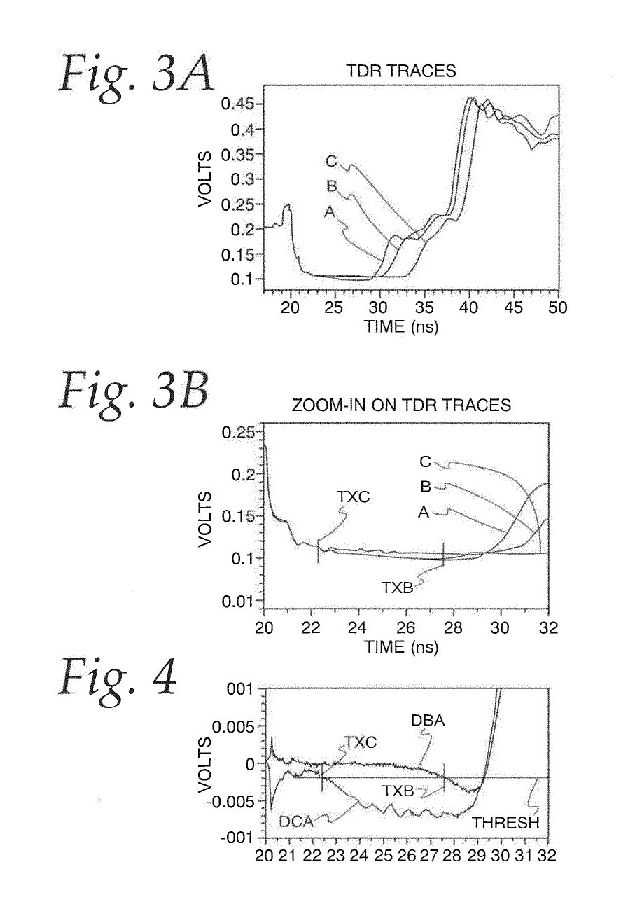

FIG. 3A gives an example of an emulsion's effect on TDR traces.

Trace A shows a bottom up TDR waveform of probe impedance over time from a column of fluid, the lower two thirds being water, the upper third being oil floating on the water. Trace C is the TDR trace after mixing with a high-shear mechanical emulsifier (not shown). Trace B is after about 40 minutes after the mixer is turned off, so that the fluid has been allowed to settle back toward the state of Trace A, but not all the way.

FIG. 3B zooms-in on the pertinent part of FIG. 3A, and FIG. 4 shows differences DBA and DCA. DBA is the difference between traces A and B, and DCA is the difference between traces A and C. The algorithm used by the controller 14 herein determines emulsion position by locating where a difference trace crosses the threshold THRESH. For example, trace B crosses at TXB, and trace C crosses at TXC. This shows that the emulsion cloud has moved higher up in the more-settled case of Trace B, which is expected since water is collecting on the bottom of the vessel 12 during the 40 minutes of settling between Trace C and Trace B.

In the illustrated embodiment the level of the threshold THRESH is −2 mV, whereas the TDR peak-to-peak is about 600 mV. This means the algorithm must find tiny deviations, <0.5% of full scale. This is a problem because temperature, salinity and oil-fouling on probe surfaces affect the water's dielectric, and those effects can easily overwhelm the small half-percent signal reflection from the cloudy water floating on clearer water.

The disclosed algorithm uses motion-detection to subtract off those static errors, leaving only moving-oil cloud differences. The algorithm disclosed herein can make use of five different motion-types: Historical Difference; Modulated Fluid; Modulated Probe; Linear Motion; or Random Motion, as described below. The memory 52 stores trace data of a plurality of individual waveforms. The processor 50 is programmed to profile a first section of the waveforms which does not change over time and a second section of the waveforms which changes over time, representing an emulsion moving in the vessel. The microprocessor 50 locates where the waveforms indicates motion to determine emulsion level.

Historical Difference Motion Detection

Trace DBA in FIG. 4 shows the difference from a trace at the current time (Trace B), subtracted from what that trace was 40 minutes ago (Trace A). The Historical Difference algorithm stores old traces in the memory 52, so that it can always subtract the current trace from some old trace, T minutes ago. In FIG. 4's example, the algorithm is presently receiving Trace B. The user has set T to 40 minutes, and the algorithm subtracts the trace from 40 minutes ago, Trace A, from the present Trace B. It applies threshold THRESH, finding TXB. The algorithm converts that time to a distance, since the wave has travelled through homogenous water to get from the bottom up to time TXB. The algorithm then reports that distance to the user, as the location 34 of the bottom of the emulsion cloud 24, see FIG. 1.

The user would set time T based on the application's rate of change. For example, if a de-watering pump caused the change, and it was known to remove 6 inches of water in 5 minutes, the user may set T to 5 minutes, and he would get an indication of where the emulsion cloud is located as it moves closer and closer to the tank bottom. This would allow the user to stop the pump 40 while there still was a foot or two of clear water on the bottom.

As another example, a user may have a temperature-controlled settling tank. A process settles over a day or two, so the user could set the time T to 4 hours, and can track this settling process.

The historical fluid motion detection algorithm gives no information in the case of non-moving fluid. Therefore, the algorithm maintains the position of the last known movement, and reports that value. The user's higher-level control system has knowledge of full column height, and pump-operations, and so can be assured that over time, the amount of water in the bottom can only increase, so the reported cloud height is a lower bound in the still fluid case.

Modulated Fluid Motion Detection

This method is useful in a system with flowing fluids, shown in FIG. 1.

The algorithm in U.S. Pat. No. 9,546,895, the specification of which is incorporated herein, provides estimates for oil interface 42, and the top of emulsion interface 48. The probe 16 includes a center conductor 68, which may be a solid rod or tube, coaxially received in an outer tube 70. The center conductor 68 is connected to the controller 14 at one end and at an opposite end via retum line 72 back to the controller 14. The controller 14 uses a downward path for measuring the oil interface 42 and top of emulsion interface 48 as described in the '895 patent. This is done by sending the signal up the return line 72 and downward via the center conductor 70. The present invention is concerned with measuring the interface level 34, and fires TDR pulses upward, via an upward path by sending the signal from the controller 14 up the conductor 70. The user integrates a modulator 74 into the Pump Controller 28, see FIG. 1. The modulator 74 controls rate of the water outlet pump 32 in a cyclic fashion, which imposes a cyclic rise/fall pattern in interface bottom level 34. The user inputs the approximate modulation period T into this algorithm.

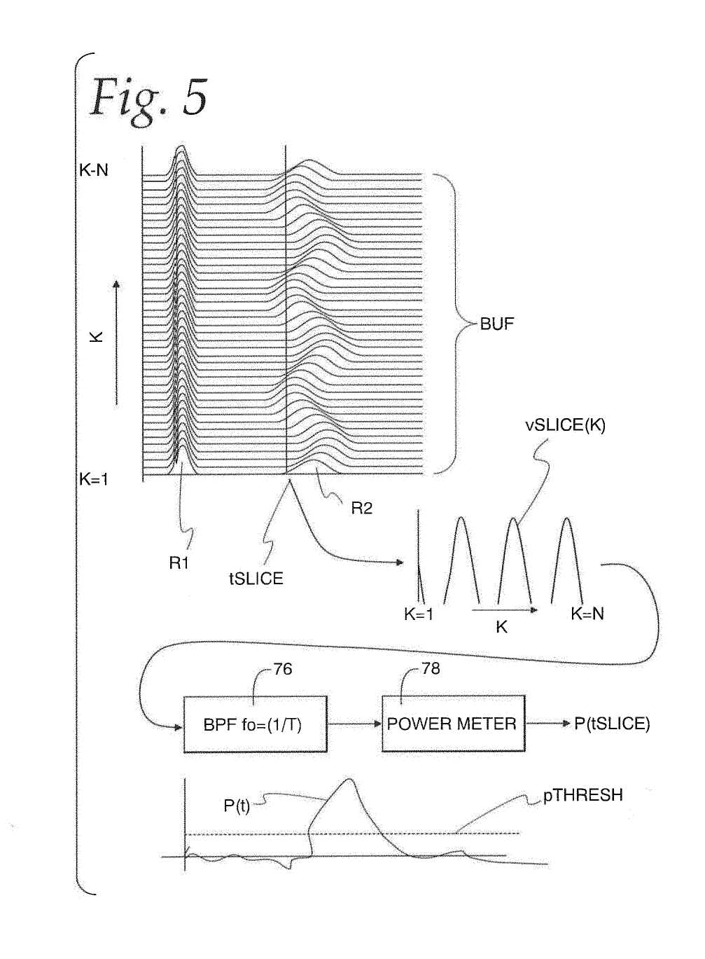

FIG. 5 shows a buffer BUF of N past Traces, which are stored in the memory 52, in the Modulated Fluid Detection case. Trace index K is 1 for the newest Trace, and N for the oldest Trace. The traces are plotted overlapping to illustrate the algorithm. There are two reflections, R1 and R2 that appear in every trace. The first reflection R1 is stationary, and the second reflection R2 moves back and forth, with the pump modulation-period T. The first reflection R1 is off a mechanical feature in the probe 16, such as a fiducial, and the second reflection R2 is off the floating emulsion cloud.

The algorithm assembles all the traces' samples at time tSlice, creating the waveform vSlice(K), see FIG. 5. vSlice(K) is now a waveform that has some amount of energy from the pumping period T, and that energy will be at Frequency fo=(1/T). The algorithm uses a Band Pass Filter (BPF) 76, and a Power Meter 78 to detect P(tSlice), the amount of fluid modulation Power at time t from the bottom of the probe 16.

The algorithm calculates P(tSlice) for all t's out to the probe's farthest reach. If tSlice is on top of R1, P(tSlice)=0, there is no motion, whereas when t is on top of R2, there is substantial P(tSlice). The algorithm finds the first time P(tSlice) that crosses the threshold pTHRESH, and indicates that as the emulsion cloud location.

This algorithm offers a tradeoff between FIG. 5's filter bandwidth, and sensitivity. Theoretically, one can increase the BUF depth, and decrease the BPF bandwidth, to detect arbitrarily small variations in dielectric. For example, if the pump period T is 2 minutes, and traces are captured every 10 seconds, and BUF was about one day deep, that would require about 10 Mbytes of RAM, and could get an average of 720 pump cycles over a full day. The BPF would reject static reflections, or reflections that move at some frequency other than the pump period.

Modulated Probe Motion Detection

The TDR waveform sees the fluid with respect to the probe 16. In the modulated fluid case, the probe 16 is stationary and the fluid moves, whereas in the Modulated Probe case, the probe has a means (not shown) of moving up and down mechanically, and the fluid stays in place. In either case, the TDR waveform will modulate the same. The algorithm is the same, but in this case the fluid can remain still. The advantage of this method is that the user does not need to ensure fluid movement.

Linear Motion Detection

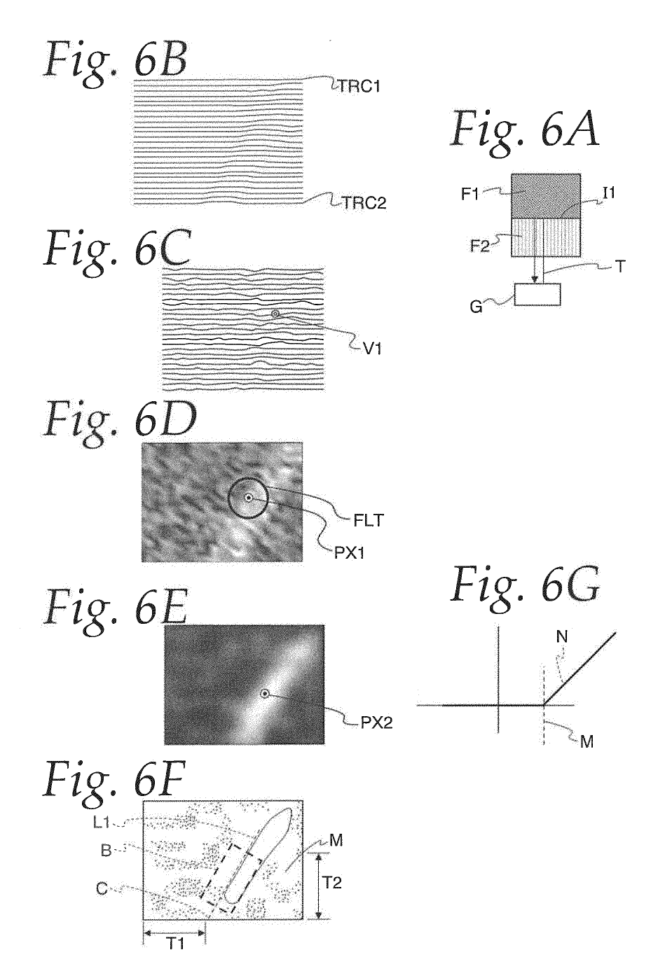

There can be applications where neither “Modulated Fluid Motion Detection” or “Historical Difference Motion Detection” are practical. For example, FIG. 6 shows an emulsion fluid F1 floating on water F2, making an interface I1. The interface I1 is known to be moving approximately linearly—either moving down due to a pump removing water F2, or moving up, due to water separating out of F1 and falling into F2. In FIG. 6, a TDR instrument G more simply depicts the actual configuration, seen in FIG. 1's instrument 10, firing TDR signals through the upward path.

The algorithm for linear motion detection visualizes a set of TDR traces as a 2 dimensional image, and then use a modified version of one of the most well-known and effective edge detectors, the Canny edge detector. There are many improvements based on the Canny Edge Detector, for example U.S. Pat. No. 6,094,508, which adjusts thresholds locally, to make the detector work more generally over a large image. The present invention goes the opposite way—it makes the detector simpler, since there is not an arbitrary image, but a constrained situation, since there is a-priori knowledge. For example, if the application is to find an interface while pumping water out, the instrument is looking for downward motion, and there is a known range of velocities based on the pump design. The controller is looking for an approximately linear segment, with slope in a known range, and length in a known range.

FIG. 6B shows a sequence of traces which level instrument G has recorded. Each trace is the difference between a TDR trace, and an older TDR trace, as described above in “Historical Difference Motion Detection”. The lowest trace TRC2 is the most recent, and the highest TRC1 is the oldest. Trace-time runs left to right, so a reflection on the left side is closest to the instrument G in FIG. 6A. All the traces show a bump, with the bumps moving from the right on the oldest trace TRC1 towards the left on the newest race TRC2, so the bump is moving closer to the bottom, meaning the FIG. 6A interface I1 is moving downwards.

FIG. 6C shows the same circumstance as in FIG. 6B, but in the FIG. 6C case fluids F1 and F2 have nearly the same dielectric, since emulsion F1 is mostly water. In such an application, the water/emulsion interface I1 provides only a very small TDR reflection T, so the traces must be amplified, showing a very poor signal to noise ratio, evidenced in FIG. 6C. FIG. 6B traces are clean enough that a simple threshold would locate the descending bumps, but the FIG. 6C traces are too noisy for a threshold to work. The Linear Motion Detection algorithm assembles the set of TDR traces from FIG. 6C into the image FIG. 6D. Each [time, voltage] point V1 from FIG. 6C transfers to a pixel PX1 on FIG. 6D. At this point human-intuition lets one see the motion, but the algorithm needs additional cleaning and analysis steps. FIG. 6E is a two-dimensional low-pass filtered version of FIG. 6D. As is typical in 2D low pass filters, all the pixels encircled by FIG. 6D's FLT get a weighted summed into the single pixel PX2 on FIG. 6E. The weighting is a raised-cosine but can be any low-pass shape. Next, each FIG. 6E pixel intensity is run through the FIG. 6G transfer-function N, which provides intensity out given intensity in, giving FIG. 6F. The FIG. 6G transfer function serves a similar purpose to the Canny Edge Detector's Non-Maximum Suppression step because it removes smaller intensity pixels. The removal cleans up and sharpens the edge, which will serve to improve the Signal to Noise ratio while looking for the edge in subsequent steps.

FIG. 6F now has a clean image of the moving fluid. The algorithm's goal is to find the line L1 which falls along the edge, and then find the intersection point C. The algorithm converts the round-trip reflection time T1 into a distance, X inches. The algorithm then knows that an emulsion has been moving downwards for T2 seconds, and now is X inches from the tank-bottom.

To find the line L1, the algorithm draws a box B, with centerline L1. The algorithm then searches for slope M and reflection distance T1, both within user-defined ranges. The search is looking for the first [M, T1] pair which meets the criteria for the edge. At each [M, T1], the algorithm calculates S1 and S2, which are the sum of all pixel intensities below and above L1, respectively. The [M, T1] pair qualify as an edge when S1 is greater than a threshold, and the ratio S over S2 above a signal-to-noise threshold.

In summary, the Linear Motion Detection algorithm started with an apparent jumble of waveforms, FIG. 6C, and provides a very clear indication of the FIG. 6A interface I1, which FIG. 6F represents as time T1.

Random Motion Detection

In this case, an interface is moving up and down a small amount, and randomly, so that the above algorithms do not apply. For example, this occurs with “slug flow”, as discussed in U.S. Pat. No. 5,544,672. In this situation, FIG. 1's flow 20 is not smooth and continuous, but varies somewhat, in spite of mitigation efforts.

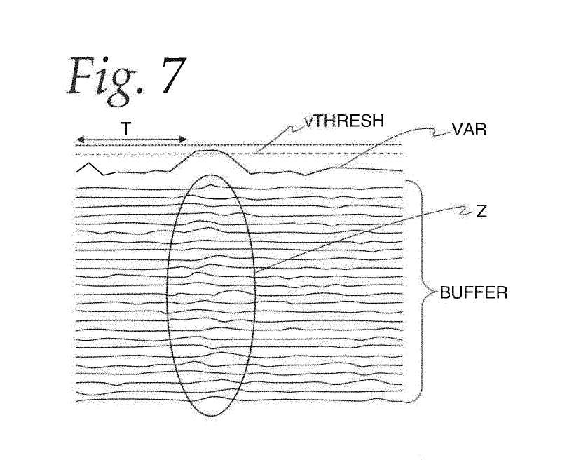

The buffer of traces in FIG. 7 show a reflection moving around in time. Looking in zone Z, there is signal there, but moving randomly. The trace Var is the point-wise variance of all the traces in the Buffer. This reveals the energy in zone Z. To determine interface location, the algorithm finds a reflection time T, which is where variance Var crosses a threshold Vthresh. The algorithm converts that reflection time into distance, given the speed through water.

Thus, in accordance with the invention, a radar transmitter for emulsion measurement uses a bottom up algorithm. A pulse circuit connected to the bottom of the probe generates upwardly traveling pulses on the probe and receives a reflected signal. The controller locates where a wave form indicates motion and reports that distance to a user representing level of the emulsion.

The present invention has been described with respect to logic descriptions and block diagrams. It will be understood that each element of the logic and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The foregoing disclosure of specific embodiments is intended to be illustrative of the broad concepts comprehended by the invention.

1. A radar transmitter for emulsion measurement comprising:
a probe mountable to a bottom of a vessel and defining a transmission line extending upward into the vessel, in use, for sensing impedance;
a pulse circuit connected to the probe for periodically generating pulses on the transmission line and receiving a reflected signal from the transmission line, each reflected signal comprising a waveform of probe impedance over time; and
a controller operatively connected to the pulse circuit and comprising a programmed processor and a memory, the memory storing trace data of a plurality of individual waveforms, the processor being programmed to profile a first section of the waveforms which does not change over time and a second section of the waveforms which changes over time, representing an emulsion moving in the vessel, the controller locating where the waveforms indicates motion to determine emulsion level.

2. The radar transmitter of claim 1 wherein the waveform comprises a time domain reflectometry signal.

3. The radar transmitter of claim 2 wherein the controller uses TDR inversion to transform the waveform into impedance relative to distance.

4. The radar transmitter of claim 1 wherein the controller is programmed to use historical difference motion detection.

5. The radar transmitter of claim 4 wherein the controller compares a current waveform to a prior waveform a select time T prior to the current waveform.

6. The radar transmitter of claim 1 wherein the controller is programmed to use modulated motion detection where there is relative movement between the emulsion and the probe.

7. The radar transmitter of claim 6 wherein modulated motion detection assembles all the waveform samples at time tSlice to create a waveform that has some amount of energy from the pumping period T, and detects a P(tSlice), the amount of fluid modulation Power at time t from the bottom of the probe for all time's out to the probe's farthest reach, and determines the first time P(tSlice) that crosses a threshold pTHRESH, and indicates that as the emulsion location.

8. The radar transmitter of claim 1 wherein the controller is programmed to use linear motion detection.

9. The radar transmitter of claim 8 wherein the linear motion detection creates an image of the moving edge from the plurality of individual waveforms and determines a slope of a line at the moving edge and an intersection point of the line along a time scale.

10. The radar transmitter of claim 1 wherein the controller uses random motion detection.

11. The radar transmitter of claim 10 wherein the random motion detection creates a variance trace that is a point wise variance of all of the plurality of waveforms in a buffer and determines a reflection time there the variance trace crosses a select threshold.

12. A time domain reflectometry measurement instrument for emulsion measurement comprising:
a probe mountable to a bottom of a vessel and defining a transmission line extending upward into the vessel, in use, for sensing impedance;
a pulse circuit connected to the probe for periodically generating pulses on the transmission line and receiving a reflected signal from the transmission line, each reflected signal comprising a waveform of probe impedance over time;
a signal processing circuit connected to the pulse circuit for developing a time representation of the reflected signal;
a memory storing trace data of a plurality of individual waveforms; and
a programmed processor operatively connected to the signal processing circuit and the memory, the processor being programmed to profile a first section of the waveforms which does not change over time and a second section of the waveforms which changes over time, representing an emulsion moving in the vessel, the controller locating where the waveforms indicates motion to determine emulsion level.

13. The time domain reflectometry transmitter of claim 12 wherein the controller uses TDR inversion to transform the waveform into impedance relative to distance.

14. The time domain reflectometry transmitter of claim 12 wherein the controller is programmed to use historical difference motion detection.

15. The time domain reflectometry transmitter of claim 14 wherein the controller compares a current waveform to a prior waveform a select time T prior to the current waveform.

16. The time domain reflectometry transmitter of claim 12 wherein the controller is programmed to use modulated motion detection where there is relative movement between the emulsion and the probe.

17. The time domain reflectometry transmitter of claim 16 wherein modulated motion detection assembles all the waveform samples at time tSlice to create a waveform that has some amount of energy from the pumping period T, and detects a P(tSlice), the amount of fluid modulation Power at time t from the bottom of the probe for all time's out to the probe's farthest reach, and determines the first time P(tSlice) that crosses a threshold pTHRESH, and indicates that as the emulsion location.

18. The time domain reflectometry transmitter of claim 12 wherein the controller is programmed to use linear motion detection.

19. The time domain reflectometry transmitter of claim 18 wherein the linear motion detection creates an image of the moving edge from the plurality of individual waveforms and determines a slope of a line at the moving edge and an intersection point of the line along a time scale.

20. The time domain reflectometry transmitter of claim 12 wherein the controller uses random motion detection.

21. The time domain reflectometry transmitter of claim 20 wherein the random motion detection creates a variance trace that is a point wise variance of all of the plurality of waveforms in a buffer and determines a reflection time there the variance trace crosses a select threshold.
